(19) United States
(12) Patent Application Publication
(10) Pub. No.: US 2007/0097809 A1
(43) Pub. Date: May 3, 2007

(54) METHOD OF ADJUSTING SPHERICAL ABERRATION AND FOCUS OFFSET IN OPTICAL DISK APPARATUS AND OPTICAL DISK APPARATUS USING THE SAME

(75) Inventor: YASUYUKI MIYAOKA, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/550,454

(22) Filed: Oct. 18, 2006

(30) Foreign Application Priority Data
Oct. 28, 2005 (JP) 2005-314515

(51) Int. Cl. G11B 7/00

(52) U.S. Cl. 369/44.23; 369/44.32

(57) ABSTRACT

Provided is a simple method of adjusting spherical aberration and a focus offset. According to the adjusting method of the present invention, focus offset adjustment and spherical aberration adjustment are performed based on the fact that the dependence of a focus offset on a spherical aberration correction value (SA) is changed between a first evaluation index indicating a track cross signal characteristic and a second evaluation index indicating a reproduction signal characteristic. A spherical aberration correction value (SA) obtained when a first focus offset and a second focus offset which are related to the first evaluation index and the second evaluation index, respectively, become optimum points is used together with a focus offset value associated with the spherical aberration correction value. Therefore, predetermined processing steps are performed to uniquely obtain an optimum spherical aberration correction value (SA) and an optimum focus offset.

### BACKGROUND OF THE INVENTION

1. Field of the Invention

The present invention relates to a method of adjusting spherical aberration and a focus offset in an optical disk apparatus and an optical disk apparatus using this method.

2. Description of the Related Art

In recent years, an increase in amount of available information has been raising the demand for a higher recording density of an optical disk. Therefore, a linear recording density on an information recording layer of the optical disk is increased or a track pitch is narrowed, thereby realizing a high recording density of the optical disk. In order to deal with the realization of the high recording density of the optical disk, it is necessary to reduce a beam diameter of a light beam focused on the information recording layer of the optical disk.

Examples of a method of reducing the beam diameter of the light beam include a method of increasing a numerical aperture (NA) of an objective lens of a condensing optical system of an optical pickup device for performing recording and reproduction on the optical disk and a method of shortening a wavelength of the light beam exited from the objective lens. It is expected that the shortening of the wavelength of the light beam can be realized by changing a light source from a red semiconductor laser to a blue-violet semiconductor laser which is on the way to practical use.

On the other hand, in order to realize an objective lens having a high numerical aperture, a method of combining a hemispherical lens to the objective lens to provide an objective lens section including two lenses (i.e., two-group lens), thereby realizing the high numerical aperture and a method of increasing the NA of a single lens have been proposed for development.

The information recording layer of the optical disk is normally covered with a cover layer to protect the information recording layer from dust and scratch. A light beam passing through the objective lens of the optical pickup device passes through the cover layer and is focused on the information recording layer located thereunder to achieve focusing. Therefore, when the light beam passes through the cover layer, spherical aberration occurs.

The spherical aberration is expressed by t×NA⁴ where “t” indicates a thickness of the cover layer and NA denotes the numerical aperture of the objective lens. That is, the spherical aberration is proportional to the thickness of the cover layer (t) and the fourth power of the numerical aperture (NA) of the objective lens. An objective lens is normally designed to cancel spherical aberration, so the spherical aberration is sufficiently small. Therefore, the light beam passing through the objective lens and the cover layer is converged on the surface of the information recording layer.

However, when the thickness of the cover glass (cover layer) is deviated from a predetermined value, the spherical aberration occurs on the light beam converged on the information recording layer, thereby increasing a beam size. Therefore, information cannot be correctly read and written. An error of the spherical aberration which is caused by a thickness error Δt of the cover glass is proportional to the thickness error Δt of the cover layer.

That is, the larger the thickness error Δt of the cover glass becomes, the larger the error of the spherical aberration becomes. In addition, the spherical aberration is proportional to the fourth power of the numerical aperture (NA), so the amount of spherical aberration caused by the thickness error Δt of the cover layer further increases with an increase in NA. Therefore, there is the case where information cannot be correctly read and written

In the case of a conventional optical disk, for example, a digital versatile disc (DVD), the numerical aperture NA of the objective lens of the optical pickup device is approximately 0.6. Therefore, the error of the spherical aberration which is caused by the thickness error Δt of the cover glass is relatively small, so that a sufficiently small light beam can be focused on the information recording layer.

In order to increase a recording information density of the optical disk in a thickness direction thereof, a multilayer optical disk in which information recording layers are stacked has been under development. For example, a DVD including two information recording layers has been already commercialized. In the case of the multilayer optical disk, a distance between the surface of the multilayer optical disk (i.e., surface of the cover layer) and each of the stacked information recording layers is changed for each information recording layer. As a result, the amount of spherical aberration caused when the light beam passes through the cover layer of the optical disk is changed for each information recording layer.

In this case, as described above, a spherical aberration difference caused between adjacent information recording layers is proportional to the interlayer thickness “t” between the adjacent information recording layers. Therefore, the amount of spherical aberration corresponding to the interlayer thickness “t” is caused. However, when a specific optical system is used for the DVD and a specific interlayer thickness is set in the DVD, a state is obtained in which recording and reproduction characteristics can be maintained without any correction of spherical aberration.

Technical development for further increasing the recording density of the DVD has been advanced by various manufacturers. A wavelength of a light source for the DVD is approximately 405 nm and the NA of the objective lens is, for example, 0.85. As described above, even when the thickness error Δt of the cover layer does not change, a spherical aberration value becomes larger with an increase in NA. Because the spherical aberration value is proportional to the fourth power of the NA, for example, a spherical aberration value which is caused by the thickness error Δt of the cover layer in the case of NA=0.85 is approximately four times that in the case of NA=0.6. As is apparent from this fact, when a higher NA such as 0.85 is obtained, the spherical aberration value which is caused by the thickness error Δt of the cover layer becomes larger

The same is expected in the case of the optical disk including the multilayer recording layer. Even when the interlayer thickness “t” between the adjacent information recording layers does not change, a spherical aberration difference becomes larger with an increase in NA of the objective lens of the optical pickup device. For example, as described above, even when the thickness error Δt does not change, a spherical aberration difference caused in the case of NA=0.85 is approximately four times that in the case of NA=0.6. When a higher NA such as 0.85 is obtained, the spherical aberration difference between the respective information recording layers becomes larger.

Therefore, the objective lens whose NA is high has a problem in which the influence of error of the spherical aberration cannot be neglected, thereby reducing the precision of information recording and reading. In order to realize the high recording density using the objective lens whose NA is high, it is necessary to correct the spherical aberration. Thus, a spherical aberration correcting mechanism and a spherical aberration correcting means have been under development and study.

When information recording and reproduction are performed in an optical disk apparatus, it is necessary to continuously form a very small beam spot having a predetermined size along an information track on a disk by an optical head device. Therefore, the optical head device performs a focus servo and a tracking servo. The focus servo is a control operation for moving the objective lens in a direction perpendicular to the disk to mainly minimize a beam spot diameter. The tracking servo is a control operation for allowing a beam spot having the minimized beam spot diameter to follow the information track.

A focal depth of converged light emitted onto an information recording surface of the optical disk is proportional to a wavelength λ thereof and inversely proportional to the square of the NA of the objective lens ((focal depth)=λ/NA²).

As is apparent from the above description, the focal depth of an optical system in which the shortening of the wavelength of the light beam and the increase in NA of the objective lens are realized to increase the recording density becomes significantly shorter than that on a current DVD or the like. Therefore, the focus servo requires a high follow-up performance.

In order to absorb the influence of the thickness error of the cover layer and a thickness difference of the cover layer which is caused by the multilayer structure, it has been proposed to introduce a spherical aberration correcting mechanism for correcting spherical aberration into a next-generation optical disk system. Therefore, it is necessary for a recording and reproduction apparatus to adjust (i.e., control) the spherical aberration correcting mechanism in some way.

A change in shape of a light spot which is caused by the spherical aberration has a complementary relationship with a change in shape of a light spot which is caused by an offset of the focus servo. Therefore, in addition to the improvement of precision of the focus control, it is necessary to detect an optimum point between spherical aberration correction and focus offset adjustment control.

An example of a method of optimally adjusting the offset of the focus servo and optimally adjusting the spherical aberration by the spherical aberration correcting mechanism in the optical disk system using the high-NA objective lens includes a method disclosed in Japanese Patent Application Laid-Open No. 2004-145987.

Japanese Patent Application Laid-Open No. 2004-145987 describes a method of detecting an optimum point between spherical aberration and a focus offset which are caused in the optical system based on an evaluation index and adjusting the spherical aberration and the focus offset To be specific, a spherical aberration correction value is varied with a state in which the optical system has a predetermined focus offset. An evaluation index is checked for each varied spherical aberration correction value to detect an optimum spherical aberration correction value.

After that, a focus offset is generated with a state in which the spherical aberration is generated based on the detected spherical aberration correction value. A focus offset value is varied. An evaluation index is checked for each varied focus offset value to detect an optimum focus offset value. Alternatively, the processing for detecting the optimum spherical aberration correction value is performed after the completion of the processing for detecting the optimum focus offset value. The optimum spherical aberration correction value and the optimum focus offset value are used as compensation values for a drive apparatus.

However, according to the method disclosed in Japanese Patent Application Laid-Open No. 2004-145987, it is necessary for the adjustment to drive the spherical aberration correcting mechanism again and again until the optimum point is detected. A mechanism for moving an optical part included in a lens group of an optical pickup device in an optical axis direction to correct the spherical aberration normally includes a stepping motor used for lens driving.

The operation response speed of the spherical aberration correcting mechanism which is caused by motor driving is several orders of magnitude smaller than the control operation speeds for focusing and tracking. When the spherical aberration correcting mechanism is operated, spherical aberration adjustment processing requires a longer adjustment time than that for focus adjustment processing or the like. A spherical aberration correcting mechanism using a liquid crystal element is also proposed. In this case, the response speed of liquid crystal is small particularly at a low temperature. Therefore, there is a problem in that a longer adjustment time is necessary as in the case of the lens driving system using the motor.

In an optical disk drive apparatus whose wavelength is short (for example, λ: 405 nm) and NA is high (NA: 0.85) as described above, an optimum adjustment on various parameters related to recording and reproduction must be an essential condition for disk insertion. Therefore, when spherical aberration correcting mechanism is driven for the adjustment again and again to perform the optimum spherical aberration correction, a necessary start-up time at the time of disk insertion becomes longer, thereby damaging the comfort of users.

### SUMMARY OF THE INVENTION

An object of the present invention is to provide a simple method of adjusting spherical aberration and a focus offset in an optical disk apparatus and an optical disk apparatus using this method.

A method of adjusting spherical aberration and a focus offset in an optical disk apparatus according to an aspect of the present invention includes the steps of:

measuring a first evaluation index indicating quality of an information track cross signal and a second evaluation index indicating quality of an information reproduction signal while changing spherical aberration correction value and focus offset value; and

determining a spherical aberration correction value and a focus offset value which are to be set, based on a result obtained by the step of measuring.

Further, an optical disk apparatus according to another aspect of the present invention includes:

a focus offset adjustment mechanism for moving an objective lens to an information recording surface of an optical disk to adjust a focus offset on a light beam;

a spherical aberration correction mechanism for correcting spherical aberration caused on the light beam emitted to the information recording surface; and

a circuit for measuring a first evaluation index indicating quality of an information reproduction signal and a second evaluation index indicating quality of an information track cross signal while relatively changing focus offset value and spherical aberration correction value and for determining a focus offset value and a spherical aberration correction value which are to be set, based on a result obtained by measurement.

Further features of the present invention will become apparent from the following description of exemplary embodiments with reference to the attached drawings.

### BRIEF DESCRIPTION OF THE DRAWINGS

FIG. 1 is a block diagram showing a structure of an optical disk apparatus according to an embodiment of the present invention.

FIG. 2 is a cross sectional view showing an example of an optical disk used for an optical disk apparatus according to the present invention.

FIG. 3 shows an example of optical disk structure used for an optical disk apparatus.

FIG. 4 is a flow chart showing spherical aberration/focus offset adjustment processing in the present invention.

FIGS. 5A, 5B, and 5C are concept diagrams showing an operation for measuring a track cross signal.

FIG. 6 is a graph showing the dependence of an amplitude of the track cross signal on a focus offset value.

FIG. 7 is a graph showing the dependence of the focus offset value on a spherical aberration correction value in the case where the amplitude of the track cross signal is estimated.

FIG. 8 is a graph showing the dependence of an amplitude of an RF reproduction signal on the focus offset value.

FIG. 9 is a graph showing the dependence of the focus offset value on the spherical aberration correction value in the case where the amplitude of the track cross signal and the amplitude of the RF reproduction signal are estimated.

FIG. 10 is a flow chart showing another example of spherical aberration/focus offset adjustment processing in the present invention.

### DESCRIPTION OF THE EMBODIMENTS

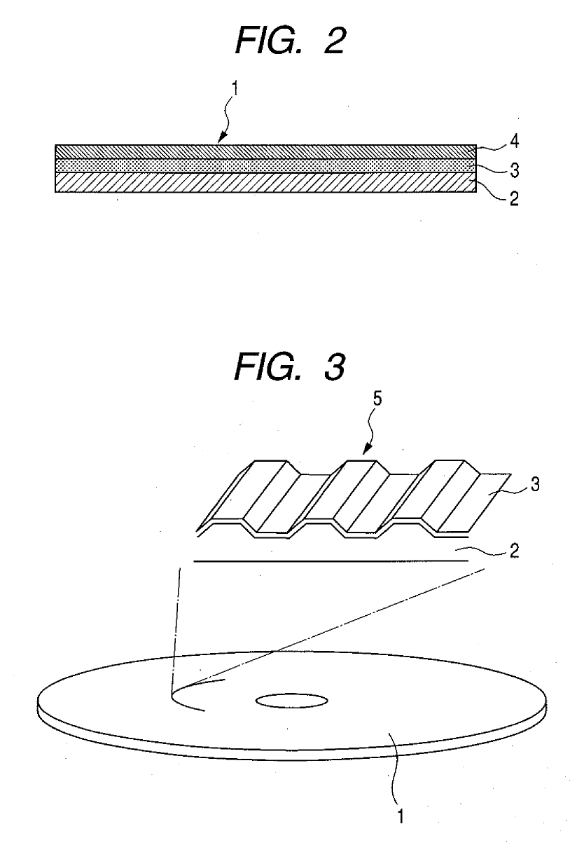

Hereinafter, the best mode for carrying out the present invention will be described in detail with reference to the attached drawings. FIG. 2 is a cross sectional view showing an example of an optical disk used for an optical disk apparatus according to the present invention. In an optical disk 1, for example, an information recording layer 3 including a phase changing recording film is formed on a substrate 2 made of polycarbonate. When the optical disk 1 is a play-only disk, the information recording layer 3 including a reflection film is used instead of the information recording layer 3 including the phase changing recording film.

A cover layer (light transmission layer) 4 having a thickness “t” is formed on the information recording layer 3. The cover layer 4 is made of a plastic material (thickness: t). The cover layer 4 is bonded as a sheet onto the information recording layer 3 formed on the substrate 2. Alternatively, the cover layer 4 is formed on the information recording layer 3 by spin coating using an ultraviolet curable resin.

FIG. 3 shows an example of the optical disk structure. The information recording layer 3 of the optical disk 1 is formed on an information recording track 5 having a spiral shape or a concentric shape. In the optical disk 1, the information recording track 5 is formed along a guide groove by a physical concave and convex pattern. Information is recorded on a concave or convex portion or both by, for example, a phase changing mark. When the optical disk 1 is a play-only disk, the information recording track 5 is formed in advance by a prepit arrangement. Reference numeral 2 denotes the substrate as shown in FIG. 2.

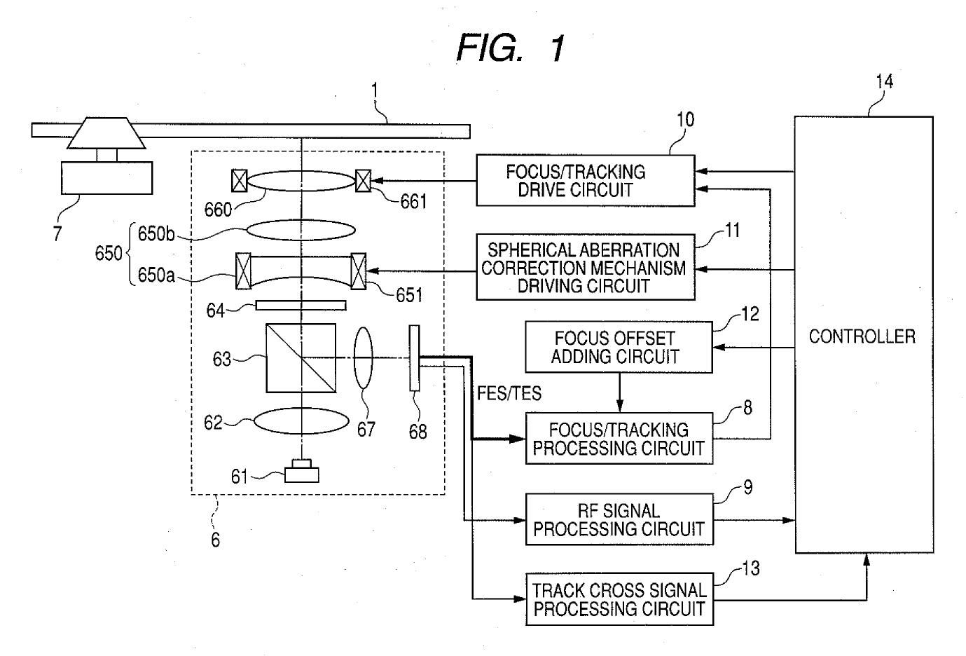

FIG. 1 is a block diagram showing an optical disk apparatus according to an embodiment of the present invention. In FIG. 1, the optical disk 1 is an optical information recording medium. The optical disk 1 is rotated by the drive of a spindle motor 7. The optical disk 1 has the structure shown in FIG. 2. An optical pickup 6 emits a light beam to the optical disk 1 to record and reproduce information.

When the recording operation or the reproduction operation is to be performed, the light beam is emitted from the optical pickup 6 to the optical disk 1. A reflected light beam is received by a photo detector 68. A receiving signal is converted into an electrical signal and supplied to a focus/tracking processing circuit 8 and an RF signal processing circuit 9 or a track cross signal processing circuit 13.

The optical pickup 6 includes a semiconductor laser 61, a collimator lens 62, a beam splitter 63, a λ/4 plate 64, a spherical aberration correcting optical system 650, a driving mechanism 651 for spherical aberration correcting optical system, and an objective lens 660. The optical pickup 6 further includes a focus/tracking actuator 661, a condensing lens 67, and the photo detector 68.

The semiconductor laser 61 generates laser beam light having predetermined optical power. The laser beam light passes through the collimator lens 62, the beam splitter 63, and the λ/4 plate 64 and then is incident on the spherical aberration correcting optical system 650 for correcting spherical aberration caused by a transmission substrate thickness error of the optical disk 1.

The spherical aberration correcting optical system 650 is, for example, a beam expansion type relay lens composed of a concave lens 650a and a convex lens 650b. The spherical aberration correcting optical system 650 is normally constructed so as to increase a beam diameter of incident parallel light to exit expanded parallel light. A lens interval between the concave lens 650a and the convex lens 650b is adjusted to convert light incident on the objective lens 660 into divergent light or convergent light Therefore, the spherical aberration can be generated by the objective lens 660 and adjusted.

A mechanism for adjusting the lens interval is the driving mechanism 651 for spherical aberration correcting optical system. Therefore, the spherical aberration correcting optical system 650 can be operated as a correcting means for correcting the spherical aberration caused by a variation in thickness of the cover layer of the optical disk 1.

The objective lens 660 focuses the laser beam light from the spherical aberration correcting optical system 650 on the information track 5 formed in the recording surface of the optical disk 1. Reflected light on the optical disk 1 is detected by the photo detector 68. A focus error signal (FES) and a tracking error signal (TES) are generated based on the output of the photo detector 68.

In the focus operation, a focus drive signal is generated based on the focus error signal (FES) to drive the focus/tracking actuator 661, thereby moving the objective lens 660 in a direction perpendicular to the disk surface of the optical disk 1. In the tracking operation, a tracking drive signal is generated based on the tracking error signal (TES) to drive the focus/tracking actuator 661, thereby moving the objective lens 660 in a radius direction (tracking direction) of the optical disk 1.

The focus error signal (FES) and the tracking error signal (TES) are generated by the focus/tracking processing circuit 8. The focus drive signal and the tracking drive signal are generated by a focus/tracking drive circuit 10.

Known examples of a method of detecting the focus error signal include an astigmatism method, a knife edge method, and a spot size detecting method. Any of the methods can be used for focus error signal detection irrespective of the essence of the present invention. Known examples of a method of detecting the tracking error signal include a push-pull method, a differential push-pull (DPP) method, and a differential phase detection (DPD) method. Any of the methods can be used for tracking error signal detection irrespective of the essence of the present invention.

The controller 14 has, for example, a function for controlling the rotation of the optical disk 1, a function for controlling the turn-on/off of the semiconductor laser 61, a function for controlling respective servo systems, a function for controlling the drive of the spherical aberration correcting mechanism, and a function for performing each evaluation index calculation processing. For example, when the optical disk 1 is loaded into the optical disk apparatus, the optical disk 1 is rotated by the drive of the spindle motor 7 at a constant linear speed, a constant rotational speed, or the like.

After the completion of preliminary processing including the rotation of the optical disk 1 and the turn-on of the semiconductor laser 61, the controller 14 outputs a focus-on signal to the focus/tracking drive circuit 10. Suitable signal processing such as a phase compensation is performed by the focus/tracking processing circuit 8. After that, a signal from the focus/tracking processing circuit 8 is inputted to the focus/tracking drive circuit 10. The focus/tracking drive circuit 10 outputs a drive signal to a focus coil of the focus/tracking actuator 661 to perform the focus control.

After the determination of the focus lock, the controller 14 outputs a tracking-on signal to the focus/tracking drive circuit 10. Suitable signal processing such as a phase compensation is performed by the focus/tracking processing circuit 8. After that, a signal from the focus/tracking processing circuit 8 is inputted to the focus/tracking drive circuit 10. The focus/tracking drive circuit 10 outputs a drive signal to a tracking coil of the focus/tracking actuator 661 to perform the tracking control.

The controller 14 outputs a signal to a focus offset adding circuit 12 to perform offset adjustment for the focus control. That is, when an offset is actively added to a servo control loop, a focus state of the beam spot can be adjusted on the optical disk 1.

The controller 14 outputs a track jump signal to the focus/tracking drive circuit 10. Then, the focus/tracking drive circuit 10 outputs a track jump drive signal to the tracking coil of the focus/tracking actuator 661 to perform the track jump control.

The control of a spherical aberration correction mechanism driving circuit 11 is an important role of the controller 14. A reproduction signal from the information recording layer 3 of the optical disk 1 is outputted from the optical pickup 6. The reproduction signal is processed by the RF signal processing circuit 9 and then sent to the controller 14. The controller 14 has various functions including a function for calculating and determining evaluation indexes for various signals.

Examples of the evaluation index for the reproduction signal include:
1. an amplitude of the reproduction signal;
2. timing jitter measurement;
3. a statistical processing value (SAM) of a likelihood difference at the time of predetermined path merging in Viterbi decoding; and
4. error rate measurement.

Examples of “1. the amplitude of the reproduction signal” include a detected maximum amplitude of the reproduction signal and a modulation transfer function (MTF) detected based on an amplitude ratio between different mark lengths.

Examples of “2. timing jitter measurement” include timing jitter measurement based on interpolation processing of sampling level values of the reproduction signal and timing jitter measurement using phase error information of a phase locked loop (PLL).

An example of “3. the statistical processing value (SAM) of the likelihood difference at the time of predetermined path merging in Viterbi decoding” is that, when maximum likelihood decoding such as Viterbi decoding is used for reproduction signal processing, a likelihood difference between paths to be selected at the time of predetermined path selection is calculated to evaluate signal quality based on a statistical processing value of the calculated likelihood difference. This evaluation index has a high correlation with an error rate, and thus has been studied in recent years.

An example of “4. error rate measurement” is that recording information and reproduction information which are known are compared with each other to measure a bit error rate.

A track cross signal is processed by the track cross signal processing circuit 13 and then sent to the controller 14. The track cross signal processing circuit 13 is a circuit for performing signal amplitude measurement processing on a push-pull signal caused at the time of track crossing or a track cross signal caused from a push-pull signal.

An adjusting method related to spherical aberration correction and focus offset adjustment in the above-mentioned structure will be described.

A fundamental concept of a method of performing spherical aberration correction and focus offset adjustment according to the present invention will be described. According to the feature of the present invention, at least two different signal evaluation indexes are used for spherical aberration correction and focus offset adjustment Each of the two evaluation indexes has the dependence of an optimum point of a focus offset value on a change in spherical aberration value. The dependence in one of the evaluation indexes is different from the dependence in the other thereof. The two evaluation indexes will be described.

The first evaluation index indicates the quality of the track cross signal on an information track. An example of the first evaluation index is an amplitude value of a track cross signal such as a push-pull signal, a differential push-pull signal caused from the push-pull signal, a divided push-pull signal (hereinafter referred to as DPP) obtained by normalizing the push-pull signal by a sum signal.

The second evaluation index indicates the quality of the reproduction signal. Typical examples of the second evaluation index include, as described above, the amplitude value of the reproduction signal, the timing jitter, the statistical processing value of the likelihood difference at the time of predetermined path merging in Viterbi decoding, and the error rate.

As described above, according to the feature of the present invention, the two evaluation indexes are used in which the dependences of optimum focus points on spherical aberration correction values are different from each other. A focus offset value and a spherical aberration correction value in which the two evaluation values become optimum points are obtained as optimum points.

Hereinafter, a method of adjusting the spherical aberration correction value and the focus offset value will be specifically described, by using the amplitude of the reproduction signal as the evaluation index indicating the quality of the reproduction signal and the amplitude of DPP signal as the evaluation index indicating the quality of the track cross signal on the information track.

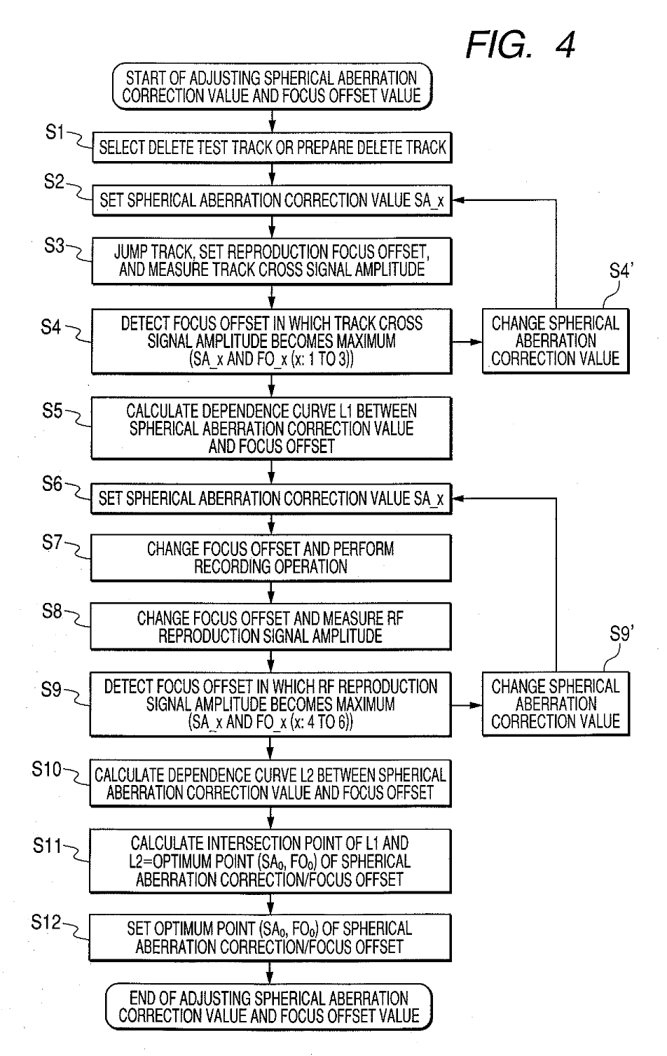

FIG. 4 is a flow chart showing the method of adjusting the spherical aberration correction value and the focus offset value according to the present invention. The method will be described with reference to the flow chart.

When the adjustment starts, the controller 14 causes the optical pickup 6 to move to a predetermined test region. In the case of a write-once medium, a test track in which at least adjacent tracks are in a non-recording state is selected in order to eliminate the influence of crosstalk during the reproduction signal amplitude measurement and the influence of a variation between a recording state and a non-recording state of the DPP signal.

In the case of an erasable and rewritable medium, a test track in which at least adjacent tracks are in a non-recording state is selected as in the above-mentioned case. Alternatively, erasing is performed on three or more tracks (Tr) sandwiching a used track. In the case of a ROM medium, it is unnecessary to particularly specify the test region. When the test region is specified, testing is performed on the track (Step S1).

Then, the dependence of focus offset on the spherical aberration correction value is measured using the amplitude of the DPP signal at the time of track crossing as the evaluation index. The driving mechanism 651 for spherical aberration correcting optical system is driven by the spherical aberration correction mechanism driving circuit 11 to set the spherical aberration correction value to SA1 (Step S2).

In this description, three correction values SA1, SA2, and SA3 are selected as the spherical aberration correction values. A typical example of the selection of the correction values is that SA2 is set as a theoretical correction value associated with a center value of a cover layer thickness in disk specifications and SA1 and SA3 are set as theoretical correction values associated with an upper limit value and a lower limit value of the cover layer thickness which are allowable in the specifications.

In the case of the spherical aberration correction value SA1, one track is divided into a plurality of divisional portions in a time division manner. The controller 14 controls to adjust a focus offset set value within a predetermined range for each of the divisional portions. This adjustment is performed by controlling the focus offset adding circuit 12 by the controller 14.

After the adjustment of the focus offset value, a jump operation to a “−1” adjacent track or a “+1” adjacent track in one divisional area is controlled by the controller 14 to return to an initial track. While such control is performed, the amplitude of the DPP signal at the time of track jump is measured by the track cross signal processing circuit 13.

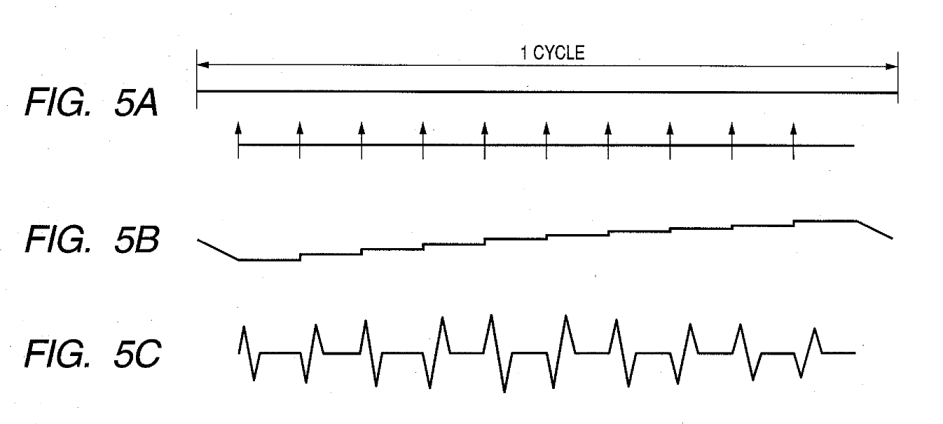

FIGS. 5A, 5B, and 5C are schematic diagrams showing a state in which track jump is performed in each of 10 divisional regions into which a track is divided. FIG. 5A shows track jump commands (indicated by arrows) from the controller 14. FIG. 5B shows a change in focus offset amount. FIG. 5C shows a change in amplitude of the DPP signal at the time of track jump.

The amplitude measuring method performed by the track cross signal processing circuit 13 is not limited. An example of the amplitude measuring method is a measurement method of sampling a peak value and a bottom value by peak/bottom detection. Even in the case of the ROM medium, it is known that a modulation factor of a push-pull signal is obtained by, for example, an optical system whose wavelength λ is 405 nm and NA is 0.85 without depending on a pit depth. Therefore, the measurement can be performed on each of the write-once medium, the erasable and rewritable medium, and the ROM medium.

As shown in FIG. 6, the dependence of a DPP amplitude on the focus offset value is obtained by measuring a DPP amplitude value during a change in focus offset (Step S3).

Polynomial approximation (quadratic approximation) is performed to calculate a focus offset value Fo1 in which the DPP amplitude value becomes maximum, thereby obtaining (SA1, Fo1) (Step S4).

The driving mechanism 651 for spherical aberration correcting optical system is driven by the spherical aberration correction mechanism driving circuit 11 to adjust the spherical aberration correction value (Step S4′) The same control and measurement as those in Steps S2 to S4′ are performed for SA2 and SA3 to calculate (SA2, Fo2) and (SA3, Fo3).

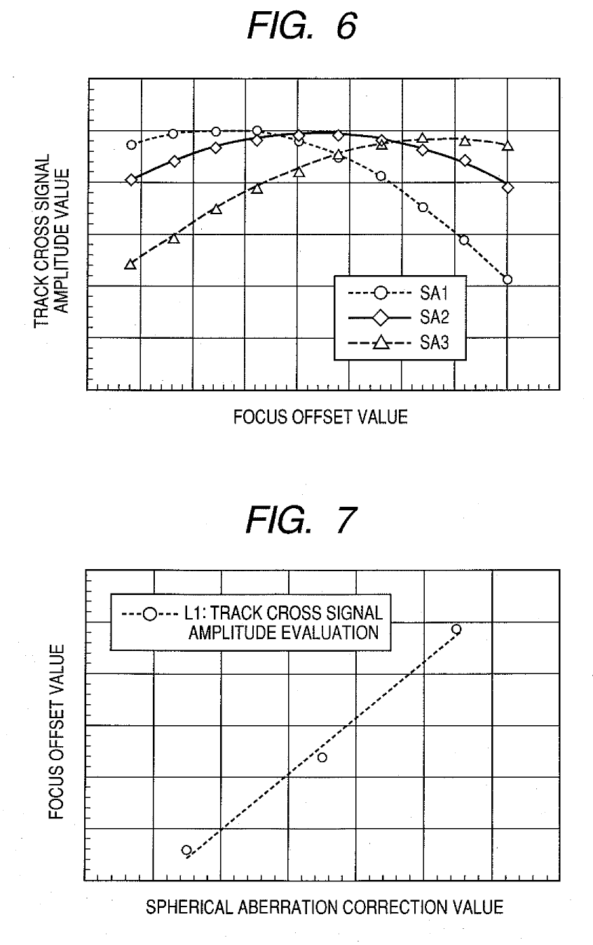

Polynomial approximation (linear approximation) is performed on (SA1, Fo1), (SA2, Fo2), and (SA3, Fo3) which are obtained as shown in FIG. 7 to calculate the dependence of an optimum focus offset value on the spherical aberration correction value (L1) (Step S5).

The measurement of the amplitude of the track cross signal which is performed based on the track jump operation is described here. However, the present invention is not limited to this. For example, it is also expected that a sine wave having a predetermined frequency is applied to the focus/tracking drive circuit 10 with a tracking servo off state to drive the objective lens 660 in a track cross direction, thereby measuring the amplitude of the track cross signal.

In this case, a large number of tracks which are in a non-recording state is necessary. However, when, for example, disk information is recorded as a wobble signal of a groove signal and a non-recording region is used for an information track, stable measurement can be performed.

Next, the dependence of focus offset on the spherical aberration correction value is measured using a signal amplitude in a reproduction signal characteristic as the evaluation index. As in the case where the amplitude of the DPP signal at the time of track crossing is used as the evaluation index, the driving mechanism 651 for spherical aberration correcting optical system is driven by the spherical aberration correction mechanism driving circuit 11 and the spherical aberration correction value is set to SA4 (Step S6). In this description, three spherical aberration correction values SA4, SA5, and SA6 are selected

A typical example of the selection of the spherical aberration correction values is that SA5 is set as a correction value associated with a center value of a cover layer thickness in disk specifications and SA4 and SA6 are set as correction values associated with an upper limit value and a lower limit value of the cover layer thickness in the specifications.

The example in which the same spherical aberration correction value is selected for different evaluation indexes to measure the dependence of focus offset is described here. However, the present invention is not necessarily limited to this example. Even when different spherical aberration correction values are applied, there is particularly no problem.

In the case of the ROM disk, recording is impossible, so the evaluation index measurement is performed during only reproduction. In contrast to this, in the case of a recordable disk, the spherical aberration dependence and the focus offset dependence can be measured with higher precision by performing the measurement including a recording operation. Changes in spherical aberration and focus offset at the time of reproduction cause a change in optical resolution due to a change in quality of a light beam, so that the quality of a reproduction signal changes.

On the other hand, when the measurement includes the recording operation, the change in optical resolution due to the change in quality of the light beam and a change in recording power density are caused to change the quality of a recording mark. As a result, the quality of a reproduction signal is changed by the synergy of recording and reproduction. Therefore, as described above, the spherical aberration dependence and the focus offset dependence can be measured with higher precision by performing the measurement including the recording operation.

It is desirable that a set value of the recording power at this time be power in which the dependence of a change in amplitude on the recording power is larger. According to the studies made by the inventors of the present invention, it has been found that, even when recording power close to optimum recording power in which an amplitude is close to a saturation state is applied, the spherical aberration dependence and the focus offset dependence can be measured with approximately the same detection sensitivity.

Hereinafter, the case where the measurement includes the recording operation will be described. In the case of the ROM disk, it is only necessary to omit the recording operation processing.

While the recording operation is performed at predetermined recording power, a track is divided into a plurality of divisional portions in a time division manner in the case of the spherical aberration correction value SA4. The controller 14 controls to adjust a focus offset set value within a predetermined range for each of the divisional portions. This adjustment is performed by controlling the focus offset adding circuit 12 by the controller 14. Therefore, recording strings in which focus offsets at the time of recording are different from one another are formed corresponding to the divisional portions (Step S7).

Subsequently, the reproduction operation is performed. Δt this time, as in the processing of Step S7, a track is divided into a plurality of divisional portions in a time division manner in the case of the spherical aberration correction value SA4. The controller 14 controls to adjust a focus offset set value within a predetermined range for each of the divisional portions.

It is unnecessary that the number of divisional portions be limited to the same value for each of two different evaluation indexes. In addition, it is unnecessary that the focus offset adjustment range be limited to the same value for each of the two different evaluation indexes. The amplitude value of the reproduction signal is measured for each focus offset value by the RF signal processing circuit 9 simultaneously with the focus control operation (Step S8).

The amplitude measuring method is not limited. The measurement method of sampling the peak value and the bottom value by peak/bottom detection is expected.

However, a method of sampling the reproduction signal at predetermined intervals and obtaining a standard deviation value of sampling values thereof is described here as a method of measuring a relative change in amplitude value of the reproduction signal. Note that the measurement is performed under a condition in which a mark portion and a non-mark portion of a recording signal in a sampling region are periodic in a sufficiently small range or the mark portion and the non-mark portion are random. Therefore, it is necessary to record such a recording signal. To be specific, the recording signal is a monotone signal or a random signal in which a digital sum value (DSV) is reduced to a sufficiently low value.

Hereinafter, additional description will be made. The reproduction signal is sampled for each divisional area at a channel clock rate for a recording data string or a clock rate which is an integral multiple of the channel clock rate. When each sampling value is expressed by Xi and the number of samples is expressed by “n”, a standard deviation value (Stdv) of sampled signal amplitudes is measured using the following expression.
Stdv=1/n{ΣXi²−[(ΣXi)²]/n}^{1/2} (1)

As is expressed in the expression (1), even when a DC component is included in the amplitude value of the reproduction signal, the average value of the sampling values is used for subtraction. Therefore, the calculation can be performed without any problem.

The maximum merit of the method is that the influence of a portion having an abnormal reflectance which is caused by scratch, dust, defect, or the like in a measurement region can be minimized for the measurement. In the measurement method based on peak/bottom detection which is described as a normal example, when the reflectance becomes significantly large or small by reflectance abnormality, peak and bottom following is performed. In addition, the peak value and the bottom value are converged to normal values with a time constant. Therefore, an amplitude value in this region is measured as a large value. Thus, accurate measurement cannot be performed in some cases.

When the standard deviation value Stdv is multiplied by a predetermined constant, an absolute value of the amplitude can be also measured. The purpose here is to measure a relative amplitude relationship, so the standard deviation value Stdv itself is used.

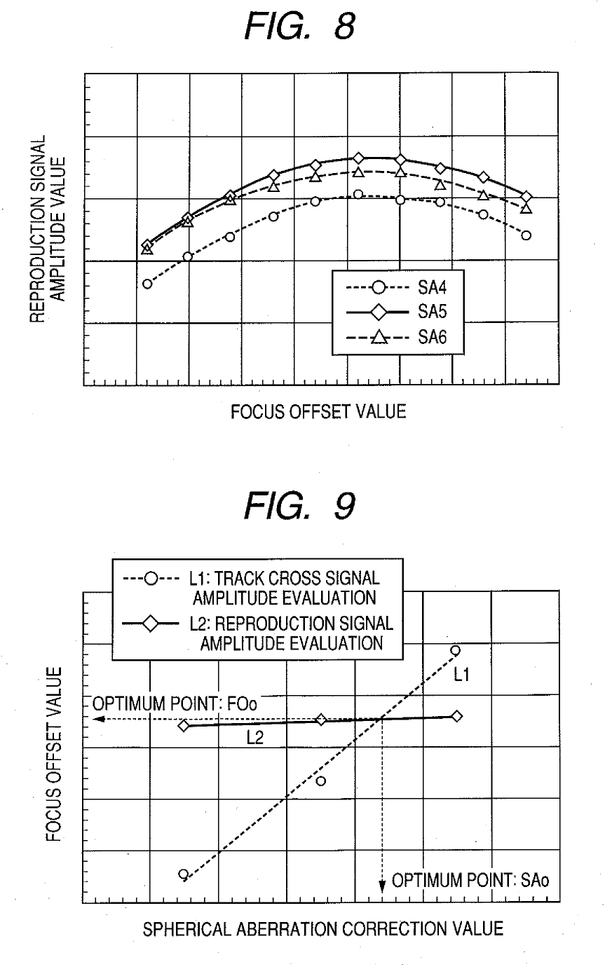

As shown in FIG. 8, the dependence of a reproduction signal amplitude on the focus offset value is obtained from the standard deviation value Stdv which is calculated from the sampling values and associated with each divisional region. Polynomial approximation (quadratic approximation) is performed to calculate a focus offset value Fo4 in which the reproduction signal amplitude value becomes maximum, thereby obtaining (SA4, Fo4) (Step S9).

Subsequently, the spherical aberration correction value is adjusted (Step S9′). The same control and measurement as those in Steps S6 to S9 and S9′ are performed for SA5 and SA6 to calculate (SA5, Fo5) and (SA6, Fo6).

Next, as in the case where the amplitude of the track cross signal is measured, polynomial approximation (linear approximation) is performed on (SA4, Fo4), (SA5, Fo5), and (SA6, Fo6) which are obtained as shown in FIG. 9. Then, the dependence of an optimum focus offset value on the spherical aberration correction value (L2) is calculated (Step S10).

When the measurement for the two kinds of evaluation indexes is completed and approximation curves of L1 and L2 are obtained, an intersection point (SA₀, Fo₀) of L1 and L2 is calculated. Therefore, an optimum spherical aberration correction value (SA₀) and an optimum focus offset value (Fo₀) of a disk which is an adjustment object are obtained (Step S11).

When recording or reproduction is to be performed on the optical disk, the spherical aberration correction value and the focus offset value (SA₀, Fo₀) which are obtained for the optical disk apparatus are set, and the procedure advances to the subsequent operation (Step S12).

In this embodiment, the three spherical aberration correction values are selected for adjustment processing. However, the present invention is not limited to this. The adjustment can be fundamentally performed using two or more measurement points. The example in which the focus offset is changed in 10 steps for the adjustment has been described. However, the present invention is not limited to this. The measurement can be performed using a minimum number of measurement points necessary for an applied approximate polynomial.

In this embodiment, the first evaluation index value is measured at each point and then the second evaluation index value is measured. However, in order to reduce the number of times of driving the spherical aberration correction mechanism in view of the shortening of time, the first evaluation index value and the second evaluation index value can be measured for each spherical aberration correction value before the adjustment of the spherical aberration correction value. According to a measurement flow in this example, the first evaluation index value and the second evaluation index value are successively measured based on a spherical aberration correction value and then the spherical aberration correction value is changed to another spherical aberration correction value. According to this flow, the number of times of spherical aberration correction for the adjustment of the spherical aberration correction value can be made smaller than that of the flow shown in FIG. 4.

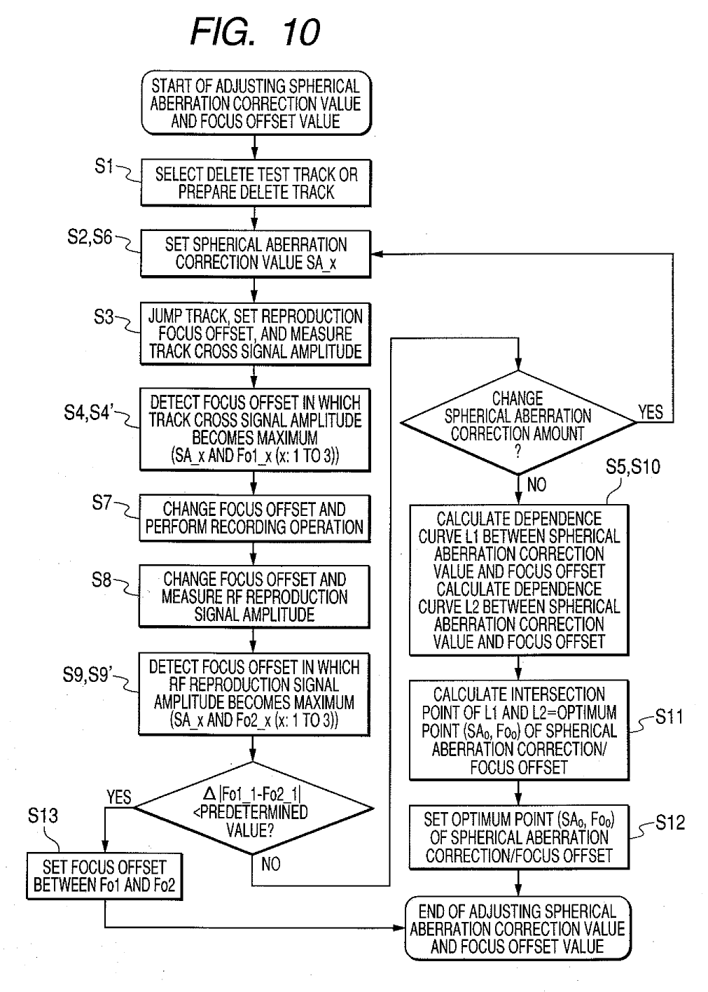

An example of a flow chart shown in FIG. 10 is also suitable. In other words, for the measurement, the spherical aberration correction value is initially set to the theoretical correction value related to the center value of the cover layer thickness in the disk specifications. Next, an optimum focus offset f1 for the first evaluation index and an optimum focus offset f2 for the second evaluation index are successively measured and a difference therebetween (Δf=|f1−f2|) is calculated. When Af is within a predetermined range, it is determined that the spherical aberration correction value is within an allowable range. Therefore, the spherical aberration correction is not performed. A flow chart of such the operation is shown in FIG. 10. In this case, the focus offset value is set to any one of f1 and f2 (Step S13) and the spherical aberration correction adjustment is completed Thus, the adjustment time can be further shortened.

It is unnecessary that the focus offset adjustment ranges be equal to each other. For example, it is expected that the offset adjustment range is changed according to the spherical aberration correction value. The example in which the amplitude of the reproduction signal is used as the evaluation index of the quality of the reproduction signal is described. However, as described above, the present invention is not limited thereto. The present invention can be naturally applied to an optical disk having a multilayer structure in which a plurality of recording layers are provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2005-314515 filed on Oct. 28, 2005, which is hereby incorporated by reference herein.

What is claimed is:

1. A method of adjusting spherical aberration and a focus offset in an optical disk apparatus, comprising the steps of:
measuring a first evaluation index indicating quality of an information track cross signal and a second evaluation index indicating quality of an information reproduction signal while changing spherical aberration correction value and focus offset value; and
determining a spherical aberration correction value and a focus offset value which are to be set, based on a result obtained by the step of measuring.

2. The method according to claim 1, wherein:
the step of measuring comprises the steps of:
measuring a relationship between the first evaluation index indicating the quality of the information track cross signal and the focus offset value for each of a plurality of spherical aberration correction values; and
measuring a relationship between the second evaluation index indicating the quality of the information reproduction signal and the focus offset value for each of the plurality of spherical aberration correction values; and
the steps of determining comprises the steps of:
calculating a first approximation curve indicating a correlation between the spherical aberration correction value and the focus offset value which are associated with the first evaluation index and a second approximation curve indicating a correlation between the spherical aberration correction value and the focus offset value which are associated with the second evaluation index, based on a result obtained by the step of measuring; and
calculating an intersection point of the first approximation curve and the second approximation curve, and determining a spherical aberration correction value and a focus offset value which are obtained at the intersection point as the spherical aberration correction value and the focus offset value which are to be set.

3. The method according to claim 2, wherein the first approximation curve and the second approximation curve are calculated by polynomial approximation in the step of calculating.

4. The method according to claim 1, wherein the first evaluation index comprises an amplitude value of a track cross signal based on a push-pull signal.

5. The method according to claim 4, wherein the amplitude value of the track cross signal is measured by measuring an amplitude value of a push-pull signal which is obtained during an track jump operation repeated a plurality of times in a measurement area.

6. The method according to claim 1, wherein the second evaluation index comprises an amplitude value of a reproduction signal.

7. The method according to claim 1, wherein the second evaluation index comprises a timing jitter value of the information reproduction signal.

8. The method according to claim 1, wherein:
the optical disk apparatus employs Viterbi decoding; and
the second evaluation index indicating the quality of the information reproduction signal is based on a statistical value of a likelihood difference at a time of predetermined path merging in the Viterbi decoding.

9. The method according to claim 1, wherein the second evaluation index comprises an error rate of the information reproduction signal.

10. The method according to claim 6, wherein the amplitude value of the reproduction signal is a value based on a standard deviation value of a sample data group obtained by sampling the reproduction signal in synchronization or asynchronization with a clock rate which is an integral multiple of a channel clock rate.

11. The method according to claim 2, wherein the second evaluation index is measured using the same spherical aberration correction value and the same focus offset value which are applied for each of a recording operation and a reproduction operation.

12. The method according to claim 2, further comprising the steps of:
determining that spherical aberration correction adjustment is unnecessary when a difference Δ51 fo1−fo2| between a focus offset value fo1 in which a first evaluation index measured for a spherical aberration correction value is an optimum value and a focus offset value fo2 in which a second evaluation index measured therefor is an optimum value is equal to or smaller than a specific value;
setting a focus offset value to a value between fo1 and fo2; and
completing the spherical aberration correction adjustment.

13. An optical disk apparatus comprising:
a focus offset adjustment mechanism for moving an objective lens to an information recording surface of an optical disk to adjust a focus offset on a light beam;
a spherical aberration correction mechanism for correcting spherical aberration caused on the light beam emitted to the information recording surface; and
a circuit for measuring a first evaluation index indicating quality of an information reproduction signal and a second evaluation index indicating quality of an information track cross signal while relatively changing focus offset value and spherical aberration correction value and for determining a focus offset value and a spherical aberration correction value which are to be set, based on a result obtained by measurement.

14. The optical disk apparatus according to claim 13, wherein the circuit measures a relationship between each of the first evaluation index indicating the quality of the information reproduction signal and the second evaluation index indicating the quality of the information track cross signal and a focus offset value for each of at least two spherical aberration correction values, calculates a first approximation curve indicating a correlation between the spherical aberration correction value and the focus offset value which are associated with the first evaluation index and a second approximation curve indicating a correlation between the spherical aberration correction value and the focus offset value which are associated with the second evaluation index based on a result obtained by measurement, calculates an intersection point of the first approximation curve and the second approximation curve, and determines a spherical aberration correction value and a focus offset value which are obtained at the intersection point as the spherical aberration correction value and the focus offset value which are to be set.

15. The optical disk apparatus according to claim 13, wherein the circuit determines that spherical aberration correction adjustment is unnecessary when a difference Δ|fo1−fo2| between a focus offset value fo1 in which a first evaluation index measured for a spherical aberration correction value is an optimum value and a focus offset value fo2 in which a second evaluation index measured therefor is an optimum value is equal to or smaller than a specific value, and determines a value between fo1 and fo2 as a focus offset value.

16. The optical disk apparatus according to claim 14, wherein the circuit calculates the first approximation curve and the second approximation curve using polynomial approximation.
